(19) United States
(12) Patent Application Publication
(10) Pub. No.: US 2016/0097340 A1
(43) Pub. Date: Apr. 7, 2016

(54) CYLINDER LINER ASSEMBLY HAVING AIR GAP INSULATION

(71) Applicant: Caterpillar Inc., Peoria, IL (US)

(72) Inventors: Bradley L. Morgan, Chillicothe, IL (US); James A. Subatch, JR., Mossville, IL (US); Michael James Pollard, Peoria, IL (US)

(73) Assignee: CATERPILLAR INC., Peoria, IL (US)

(21) Appl. No.: 14/505,985

(22) Filed: Oct. 3, 2014

(51) Int. Cl. F02F 1/00; F02F 1/10; F02F 7/00; F02F 11/00

(52) U.S. Cl. CPC F02F 1/004; F02F 11/005; F02F 1/10; F02F 7/0002

(57) ABSTRACT

A cylinder liner assembly is disclosed for use with an engine. The cylinder liner assembly may have a liner with a hollow, generally cylindrical body extending from a top end to a bottom end along a longitudinal axis. The cylinder liner assembly may also have a seal disposed around the liner at the top end and an anti-polishing ring disposed within the top end of the liner. The anti-polishing ring may have an annular groove formed on an outer surface to provide an air gap between the anti-polishing ring and the liner. The annular groove may axially overlap at least a portion of the seal.

### TECHNICAL FIELD

The present disclosure relates generally to a cylinder liner assembly and, more particularly, to a cylinder liner assembly having air gap insulation.

### BACKGROUND

An internal combustion engine includes an engine block defining a plurality of cylinder bores, and pistons that reciprocate within the cylinder bores to generate mechanical power. Typically, each cylinder bore includes a replaceable liner. The liner has a cylindrical body that fits within the cylinder bore. In some embodiments, a cavity is formed within the cylinder block around the liner, and coolant is directed through the cavity to cool the liner. A seal is placed around the liner to inhibit coolant from leaking out of the cavity.

In some applications, an anti-polishing ring is fitted into an upper end of the liner at the flange. The anti-polishing ring has an inner diameter that is slightly smaller than an inner diameter of the liner, and functions to scrape carbon deposits off a top land of the associated piston. The carbon deposits, if left intact could eventually rub against the liner, polishing away oil retaining grooves in the liner.

Although an anti-polishing ring may be effective at removing carbon buildup from a piston, it may also be possible for too much heat to pass through the ring to the seal. In these situations, the seal could overheat and turn brittle or crack. When the seal integrity is compromised, coolant from the cavity below the seal may leak out of the engine block. This could cause overheating of the engine, contamination of other engine fluids (e.g., of engine oil), corrosion, and other similar problems.

U.S. Pat. No. 7,726,267 (“the '267 patent”) discloses a cylinder liner with an insert ring having numerous feet that define a plurality of annular air gaps. The air gaps are designed to reduce heat transfer from the ring to the liner. However, the '267 patent is specifically directed to top-flange liners that do not require a seal at the ring. Furthermore, the number of feet of the '267 patent can increase a contact area between the insert ring and the liner that increases heat transfer, and the manufacturing of the multiple air gaps increases machining costs of the ring.

The cylinder liner assembly of the present disclosure solves one or more of the problems set forth above and/or other problems in the art.

### SUMMARY

In one aspect, the present disclosure is directed to a cylinder liner assembly. The cylinder liner assembly may include a liner with a hollow, generally cylindrical body extending from a top end to a bottom end along a longitudinal axis. The cylinder liner assembly may also include a seal disposed around the liner at the top end, and an anti-polishing ring disposed within the top end of the liner. The anti-polishing ring may have an annular groove formed on an outer surface to provide an air gap between the anti-polishing ring and the liner. The annular groove may axially overlap at least a portion of the seal.

In another aspect, the present disclosure is directed to an anti-polishing ring. The anti-polishing ring may include a hollow, generally cylindrical body. The anti-polishing ring may include a single annular groove formed on an outer surface of the hollow, generally cylindrical body to provide an air gap around the anti-polishing ring. The anti-polishing ring may further include a pair of feet disposed at opposing ends of the single annular groove.

In yet another aspect, the present disclosure is directed to an engine. The engine may include a cylinder block at least partially defining a plurality of cylinder bores, a cylinder liner assembly disposed within each of the plurality of cylinder bores, and a water jacket formed between an annular wall of each cylinder liner assembly and a corresponding one of the plurality of cylinder bores. Each cylinder liner assembly may include a liner having a hollow generally cylindrical body extending from a top end to a bottom end along a longitudinal axis. The liner may include a flange having a block-engaging surface located an axial length from a top surface that is 25-60% of a length of the liner. Each cylinder liner assembly may also include a seal disposed around the liner at the top end, and an anti-polishing ring disposed within the top end of the liner. The anti-polishing ring may have a single annular groove formed on an outer surface and centered axially with the seal. The single annular groove may provide an air gap between the anti-polishing ring and the liner. The anti-polishing ring may further include a first foot on a first end of the single annular groove and a second foot on a second end of the single annular groove.

### BRIEF DESCRIPTION OF THE DRAWINGS

FIG. 1 is a cross-sectional illustration of an exemplary disclosed engine;

FIG. 2 is a cross-sectional illustration of an exemplary disclosed cylinder liner assembly that may be used in conjunction with the engine of FIG. 1.

### DETAILED DESCRIPTION

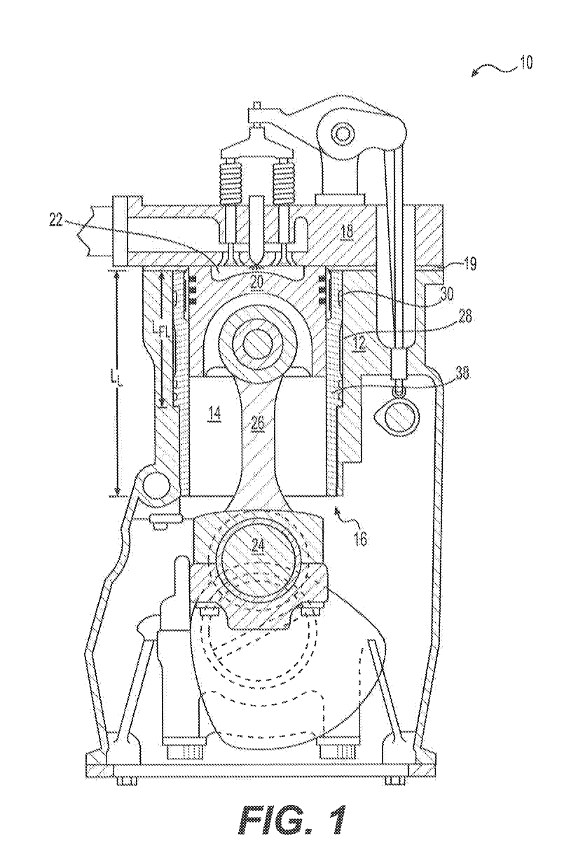

FIG. 1 illustrates a portion of an exemplary internal combustion engine 10. Engine 10 may include an engine block 12 defining at least one cylinder bore 14. A cylinder liner assembly 16 may be disposed within cylinder bore 14, and a cylinder head 18 may be connected to engine block 12 to close off an end of cylinder bore 14 (e.g., by way of a head gasket 19). A piston 20 may be slidably disposed within cylinder liner assembly 16, and piston 20 together with cylinder liner assembly 16 and cylinder head 18 may define a combustion chamber 22. It is contemplated that engine 10 may include any number of combustion chambers 22 and that combustion chambers 22 may be disposed in an “in-line” configuration, in a “V” configuration, in an “opposing-piston” configuration, or in any other suitable configuration.

Piston 20 may be configured to reciprocate within cylinder liner assembly 16 between a top-dead-center (TDC) position and a bottom-dead-center (BDC) position to facilitate a combustion process with combustion chamber 22. In particular, piston 20 may be pivotally connected to a crankshaft 24 by way of a connecting rod 26, so that a sliding motion of each piston 20 within cylinder liner assembly 16 results in a rotation of crankshaft 24. Similarly, a rotation of crankshaft 24 may result in a sliding motion of piston 20. In a two-stroke engine, piston 20 may move through two full strokes to complete a combustion cycle that includes a power/exhaust/intake stroke (TDC to BDC) and an intake/compression stroke (BDC to TDC). In a four-stroke engine, piston 20 may move through four full strokes to complete a combustion cycle that includes an intake stroke (TDC to BDC), a compression stroke (BDC to TDC), a power stroke (TDC to BDC), and an exhaust stroke (BDC to TDC). Fuel (e.g., diesel fuel, gasoline, gaseous fuel, etc.) may be injected into combustion chamber 22 during the intake strokes of either combustion cycle. The fuel may be mixed with air during the compression strokes and ignited. Heat and pressure resulting from the fuel/air ignition may then be converted to useful mechanical power during the ensuing power strokes. Residual gases may be discharged from combustion chamber 22 during the exhaust strokes.

Heat from the combustion process described above that could damage engine 10, if unaccounted for, may be dissipated from cylinder bore 14 by way of a water jacket 28. Water jacket 28 may be located between an internal wall of cylinder bore 14 and an external wall of cylinder liner assembly 16. For example, water jacket 28 may be formed by a recess within engine block 12 at the internal wall of cylinder bore 14 and/or within the external wall of cylinder liner assembly 16. It is contemplated that water jacket 28 may be formed completely within engine block 12 around cylinder liner assembly 16, formed completely within cylinder liner assembly 16, and/or formed by a hollow sleeve (not shown) that is brazed to either one of engine block 12 or cylinder liner assembly 16, as desired. Water, glycol, or a blended mixture may be directed through water jacket 28 to absorb heat from engine block 12 and cylinder liner assembly 16.

A seal 30 may be disposed around cylinder liner assembly 16 to seal off an upper end of water jacket 28. Seal 30 may be sandwiched between an outer wall of cylinder liner assembly 16 and an inner wall of cylinder bore 14 after assembly, such that coolant within water jacket 28 is inhibited from leaking out of engine block 12 through a top of cylinder bore 14. Seal 30 may be, for example, an o-ring type seal fabricated from an elastomeric material. Seal may be secured within an external groove 46 of the cylindrical liner assembly 16.

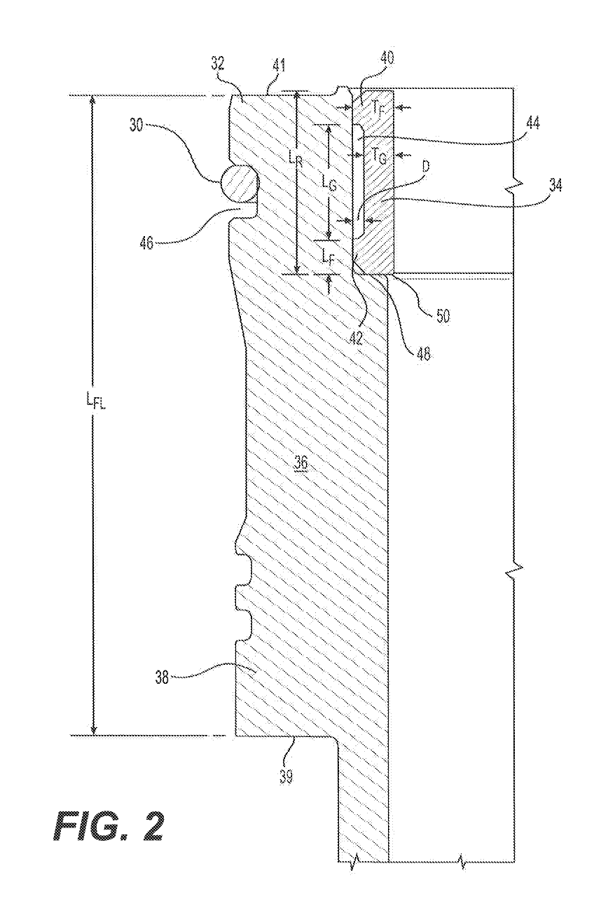

As shown in FIG. 2, cylinder liner assembly 16 may be an assembly of at least two main components, including a cylinder liner (“liner”) 32 and an anti-polishing ring or cuff (“ring”) 34. Each of liner 32 and ring 34 may be made of the same general material, for example from an alloyed gray iron. Ring 34 may be fitted into an upper or external end of liner 32 prior to assembly of cylinder liner assembly 16 into cylinder bore 14 of engine block 12. In this position, ring 34 may be configured to receive a top land of piston 20 (referring to FIG. 1). In particular, the top end of piston 20 may slide into ring 34 a distance during each upward stroke that allows ring 34 to scrape away any carbon deposits that have built up on the outer annular surface of piston 20 at a location above any associated piston rings. By scraping away the carbon deposits, the life of engine 10 may be extended.

Liner 32 may have a hollow, generally cylindrical body 36 extending along a longitudinal axis. Liner 32 may be in the form of a mid-flanged liner, at least partially defined by a flange 38 extending along a mid portion of body 36. Flange 38 may have a plurality of circumferential grooves and tapers, and may define an end surface of water jacket 28. Liner 32 may have an axial length L_{L} of about 300-400 mm (e.g. about 379 mm), and flange 38 may have a block-engaging surface 39 located at an axial length L_{FL} of about 100-200 mm (e.g. about 115 mm) from a top surface 41. Axial length L_{FL} of flange 38 may be about 25-60% of the axial length L_{L} of liner 32.

Seal 30 may be retained at a desired axial location on liner 32 (e.g., at least partially overlapping ring 34) by an external groove 46 located on the outer wall of liner 32, at a location above flange 38.

Ring 34 may be fitted into an annular recess 48 formed at the top end of body 36, and have an internal diameter less than an internal diameter of body 36. With this configuration, a step 50 may be created that interacts with piston 20 to scrape away the carbon buildup described above.

Ring 34 may have an annular groove 44 formed in an exterior surface to provide an air gap that functions as an insulator. This insulator may inhibit heat transfer from combustion chamber 22 to seal 30. In particular, the air gap may be defined by a first foot 40 and a second foot 42 spaced an axial distance apart at opposing ends of annular groove 44. Ring 34 may have two feet 40, 42 and a single air gap, such that ring 34 annularly contacts the liner at only two locations. This configuration may help to reduce an amount of heat transfer due to contact. However, in other embodiments, ring 34 may have more than two feet 40, 42 defining a plurality of annular grooves 44.

Ring 34 may have an axial length L_{R} of about 15-25 mm (e.g. 17.1 mm). Ring 34, at first foot 40 and second foot 42, may have a circumferential thickness T_{F} of about 3-5 mm (e.g. about 3.7 mm) and an axial length L_{F} of about 2-5 mm (e.g. about 3.2 mm). The longitudinal end surfaces of each of first foot 40 and second foot 42 may have a sharp edge, a taper, or a chamfer. Ring 34, at annular groove 44, may have a circumferential thickness T_{G} of about 1.5-2.5 mm (e.g. about 2.2 mm) and an axial length L_{G} of about 8-12 mm (e.g. about 9.0 mm), such that a depth D of annular groove 44 may be about 0.5-2.5 mm (e.g. about 1.5 mm).

Axial length L_{R} of ring 34 may be less than 65% of axial length L_{FL} of flange 38. In one embodiment, axial length L_{R} of ring 34 may be less than 30% of axial length L_{FL} of flange 38. Axial length L_{G} of annular groove 44 may be about 75% of axial length L_{R} of ring 34. Axial length L_{G} of annular groove 44 may be about 3 times axial length L_{F} of first foot 40 and second foot 42. Axial length L_{G} of annular groove 44 may be about 6 times depth D of annular groove 44. The dimensions of ring 34 may be selected to reduce a desired amount of heat transfer.

Annular groove 44 may be designed, in combination with the thicknesses of liner 32 and ring 34, to provide a desired temperature at seal 30 during operation of engine 10. Specifically, annular groove 44 on ring 34 may be positioned to at least partially axially overlap seal 30. Seal 30 may be axially positioned between first foot 40 and second foot 42. Preferably, seal 30 may be positioned within a lower two-thirds of the axial length L_{G} of annular groove 44. In the disclosed embodiment, seal 30 is substantially centered relative to the axial length L_{G} of annular groove 44. By doing so, the insulation provided by the air gap of annular groove 44 may reduce the amount of heat transferred to seal 30 and, thereby, extend the life of seal 30.

### INDUSTRIAL APPLICABILITY

The disclosed cylinder liner assembly may be used in any application where it is desired to increase the reliability and operating life of the associated engine. The disclosed cylinder liner assembly may increase reliability and operating life by lowering a temperature experienced by a seal installed on a cylinder liner of the assembly. This temperature may be lowered through the use of a uniquely designed air gap insulation located at an annular interface between the cylinder liner and an associated anti-polishing ring. This uniquely designed air gap insulation may also reduce machining costs in forming the cylinder liner assembly.

It will be apparent to those skilled in the art that various modifications and variations can be made to the disclosed cylinder liner assembly. Other embodiments will be apparent to those skilled in the art from consideration of the specification and practice of the disclosed cylinder liner assembly. It is intended that the specification and examples be considered as exemplary only, with a true scope being indicated by the following claims and their equivalents.

What is claimed is:

1. A cylinder liner assembly, comprising:
a liner having a hollow, generally cylindrical body extending from a top end to a bottom end along a longitudinal axis;
a seal disposed around the liner at the top end; and
an anti-polishing ring disposed within the top end of the liner, the anti-polishing ring having an annular groove formed on an outer surface to provide an air gap between the anti-polishing ring and the liner,
wherein the annular groove axially overlaps at least a portion of the seal.

2. The cylinder liner assembly of claim 1, wherein the annular groove has an axial length extending between a first foot and a second foot, and the seal is axially positioned along the axial length.

3. The cylinder liner assembly of claim 2, wherein the seal is axially positioned in a lower two-thirds of the axial length.

4. The cylinder liner assembly of claim 3, wherein the seal is substantially centered relative to the axial length of the annular groove.

5. The cylinder liner assembly of claim 1, further including:
a first foot disposed at a first end of the annular groove; and
a second foot disposed at a second end of the annular groove.

6. The cylinder liner assembly of claim 5, wherein the anti-polishing ring annularly contacts the liner at only the first foot and the second foot.

7. The cylinder liner assembly of claim 6, wherein the annular groove is the only annular groove formed within the anti-polishing ring.

8. The cylinder liner assembly of claim 1, wherein the liner forms a flange having a block-engaging surface located an axial length from a top surface that is 25-60% of a length of the liner.

9. The cylinder liner assembly of claim 8, wherein the anti-polishing ring has a length less than 65% of the length of the flange.

10. The cylinder liner assembly of claim 9, wherein the anti-polishing ring has a length less than 30% of the length of the flange.

11. The cylinder liner assembly of claim 1, wherein an axial length of the annular groove is about 6 times a depth of the annular groove.

12. The cylinder liner assembly of claim 1, wherein an axial length of the annular groove is about 75% of a length of the anti-polishing ring.

13. The cylinder liner assembly of claim 1, wherein the anti-polishing ring is disposed within an annular recess of the liner.

14. The cylinder liner assembly of claim 13, wherein the seal is disposed within an external groove of the liner.

15. The cylinder liner assembly of claim 1, wherein the seal is an elastomeric ring.

16. An anti-polishing ring, comprising:
a hollow, generally cylindrical body;
a single annular groove formed on an outer surface of the hollow, generally cylindrical body to provide an air gap around the anti-polishing ring; and
a pair of feet disposed at opposing ends of the single annular groove.

17. The anti-polishing ring of claim 16, wherein an axial length of the single annular groove is about 3 times an axial length of each pair of feet.

18. The anti-polishing ring of claim 16, wherein an axial length of the single annular groove is about 6 times a depth of the single annular groove.

19. The anti-polishing ring of claim 16, wherein an axial length of the single annular groove is about 75% of an axial length the hollow, generally cylindrical body.

20. An engine, comprising:
a cylinder block at least partially defining a plurality of cylinder bores;
a cylinder liner assembly disposed within each of the plurality of cylinder bores; and
a water jacket formed between an annular wall of each cylinder liner assembly and a corresponding one of the plurality of cylinder bores,
wherein each cylinder liner assembly includes:
a liner having a hollow generally cylindrical body extending from a top end to a bottom end along a longitudinal axis, the liner having a flange having a block-engaging surface located an axial length from a top surface that is 25-60% of a length of the liner;
a seal disposed around the liner at the top end; and
an anti-polishing ring disposed within the top end of the liner, the anti-polishing ring including a single annular groove formed on an outer surface and centered axially with the seal, a first foot on a first end of the single annular groove, and a second foot on a second end of the single annular groove, wherein the single annular groove provides an air gap between the anti-polishing ring and the liner.
